(19) United States
(12) Patent Application Publication
(10) Pub. No.: US 2020/0047725 A1
(43) Pub. Date: Feb. 13, 2020

(54) HYBRID POWER BRAKE CONTROL SYSTEM AND CONTROL METHOD THEREOF

(71) Applicant: Acer Incorporated, New Taipei City (TW)

(72) Inventors: Chih-Kai Wang, New Taipei City (TW); Shao-Chi Chuang, New Taipei City (TW); Wen-Shu Lee, New Taipei City (TW); Tsung-Hsun Wu, New Taipei City (TW); Kuo-Hui Chang, New Taipei City (TW)

(73) Assignee: Acer Incorporated, New Taipei City (TW)

(21) Appl. No.: 16/234,574

(22) Filed: Dec. 28, 2018

(30) Foreign Application Priority Data
Aug. 7, 2018 (TW) 107127451

(51) Int. Cl. B60T 7/04

(52) U.S. Cl. CPC B60T 7/042

(57) ABSTRACT

A hybrid power brake control system and a control method thereof are provided. The hybrid power brake control system includes a computer, a motor, a connecting rod set, and a pedal brake. The motor is electrically connected with the computer, the connecting rod set includes the first connecting rod and the second connecting rod, the first connecting rod is connected with the motor, the first terminal end of the second connecting rod is connected with the first connecting rod, and the pedal brake is pivotally connected with the second terminal end of the second connecting rod.

### CROSS-REFERENCE TO RELATED APPLICATION

This application claims the priority benefit of Taiwan application serial no. 107127451, filed on Aug. 7, 2018. The entirety of the above-mentioned patent application is hereby incorporated by reference herein and made a part of this specification.

### BACKGROUND

### Field of the Disclosure

The disclosure relates to a control system and a control method, and more specifically relates to a hybrid power brake control system and a control method thereof.

### Description of Related Art

The breaking function of the existing brake control system is usually controlled by the computer or by human.

However, in a vision of electric vehicle development, the breaking function is simply controlled be the computer so the risk of the car accident cannot be completely avoided. In some countries, there is news about electric car accident causing casualties, and the reason of accident may include the sensor not effectively sensing objects, which cause danger, around the vehicle or failure of computer control system in the car.

In case of the breaking function being simply controlled by human, poor physical or mental condition of the driver may also cause accident.

### SUMMARY

The disclosure provides a hybrid power brake control system that is controlled by computer or human at the same time.

The disclosure provides a control method of hybrid power brake control system that is controlled by computer or human at the same time.

The hybrid power brake control system of the disclosure includes a computer, a motor, a connecting rod set, and a pedal brake. The motor is electrically connected with the computer, the connecting rod set includes a first connecting rod and a second connecting rod, the first connecting rod is connected with the motor, the first terminal end of the second connecting rod is connected with the first connecting rod, and the pedal brake is pivotally connected with a second terminal end of the second connecting rod.

In one embodiment of the disclosure, the computer includes a judging unit and the first sensor electrically connected with the judging unit, wherein the first sensor transmits a first sensing result to the judging unit.

In one embodiment of the disclosure, the judging unit activates the pedal brake via the first sensing result for braking.

In one embodiment of the disclosure, the computer further includes a second sensor, the second sensor senses a change caused by the pedal brake and transmits a second sensing result to the judging unit for braking.

In one embodiment of the disclosure, the second sensing result includes a pressure change of the pedal brake, a torque change of the motor, and a change in current value of the motor.

In one embodiment of the disclosure, the first connecting rod has an arc-shaped slot, the first terminal end of the second connecting rod is engaged into the arc-shaped slot, and the first terminal end is movable along the arc-shaped slot.

The control method of hybrid power brake control system in the disclosure at least includes following steps: providing a hybrid power brake control system, wherein the hybrid power brake control system includes a computer, a motor, a connecting rod set, and a pedal brake, the motor is electrically connected with the computer, and the motor and the pedal brake are connected by the connecting rod set in between; and activating the pedal brake via a first sensing result for braking by the judging unit when a first sensor of the computer transmits the first sensing result to the judging unit of the computer.

In one embodiment of the disclosure, the control method further comprises a step: when a second sensor of the computer senses a change caused by the pedal brake, a second sensing result is transmitted to the judging unit of the computer.

In one embodiment of the disclosure, when receiving the second sensing result, the judging unit cancels an instruction of activating the pedal brake for braking.

In one embodiment of the disclosure, the second sensing result includes a pressure change of the pedal brake, a torque change of the motor, and a change in current value of the motor.

Based on the above, via the hybrid power brake control system and the control method thereof in the disclosure, human can still intervene in the break control system while the vehicle is under computer control, so that safety is double guaranteed.

In order to make the aforementioned and other features and advantages of the disclosure more comprehensible, embodiments accompanying figures are described in detail belows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a hybrid power brake control system of the disclosure.

FIG. 2 is a schematic view illustrating when the hybrid power brake control system in FIG. 1 performs braking.

FIG. 3 is a flow chart illustrating a control method of hybrid power brake control system.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

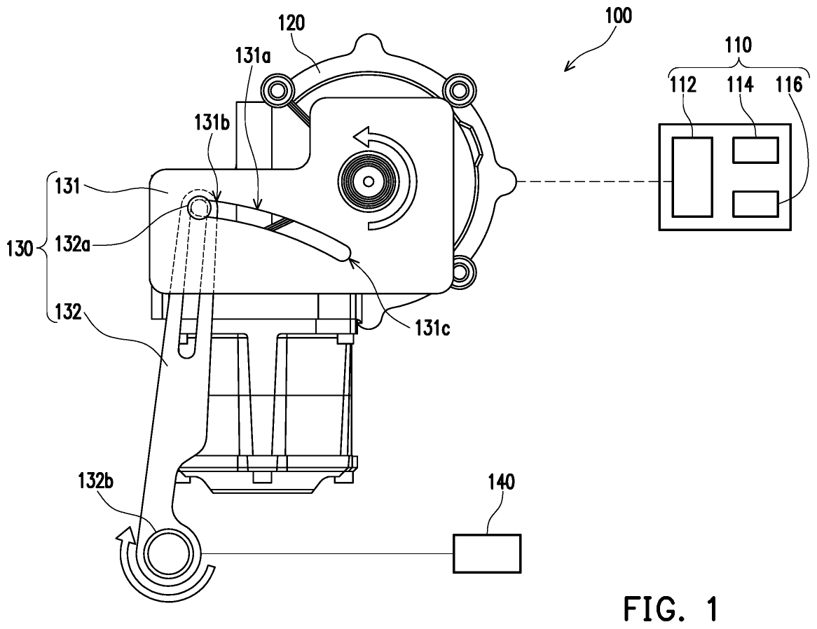

FIG. 1 is a schematic view of a hybrid power brake control system of the disclosure. Referring to FIG. 1, a hybrid power brake control system 100 is applied to a vehicle, so as to break (slow down or stop) the vehicle that is automatically driven by a computer or is driven by a driver. The hybrid power brake control system 100 includes a computer 110, a motor 120, a connecting rod set 130, and a pedal brake 140. The motor 120 is electrically connected with the computer 110, the connecting rod set 130 includes a first connecting rod 131 and a second connecting rod 132, the first connecting rod 131 is connected with the motor 120, a first terminal end 132a of the second connecting rod 132 is connected with the first connecting rod 131, and the pedal brake 140 is pivotally connected with the second terminal end 132b of the second connecting rod 132.

In reference to the above-mentioned, the computer 110 includes a judging unit 112 and the first sensor 114 electrically connected with the judging unit 112. The first sensor 114 of the present embodiment is an optical sensor that may be installed at any position outside of the vehicle and that is used to sense whether there is any object at the vicinity of the vehicle and may cause danger, such as a suddenly appearing person, obstructions on the road, etc. When sensing that there is an object may cause danger, the first sensor 114 transmits a first sensing result to the judging unit 112.

In addition, the computer 110 further includes the second sensor 116 electrically connected with the judging unit 112, the second sensor 116 is used to sense the change caused by the pedal brake 140 and transmits a second sensing result to the judging unit 112 to perform braking. The second sensing result sensed by the second sensor 116 includes a pressure change of the pedal brake 140, a torque change of the motor 120, and a change in current value of the motor 120.

The first connecting rod 131 has an arc-shaped slot 131a, the first terminal end 132a of the second connecting rod 132 is engaged into the arc-shaped slot 131a, and thus the first terminal end 132a is movable along the arc-shaped slot 131a to perform breaking function.

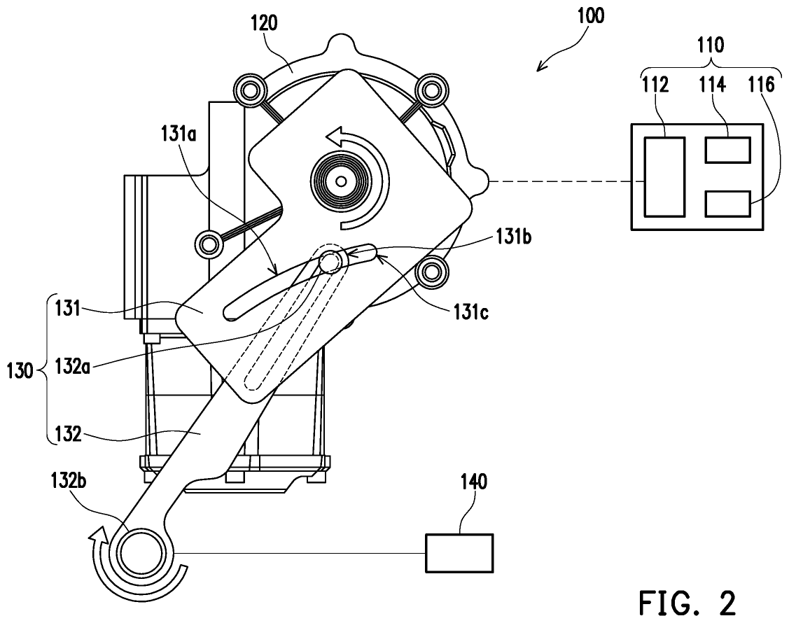

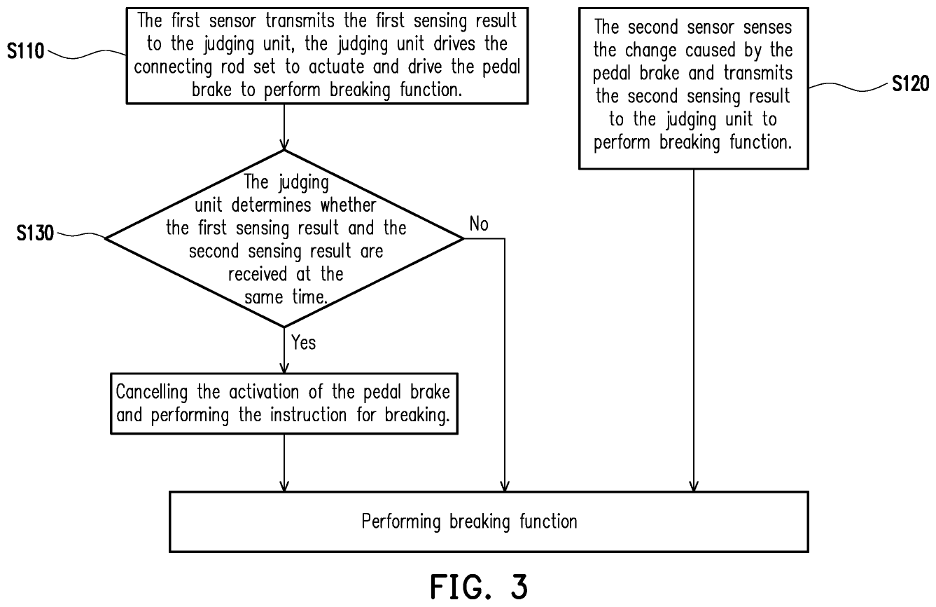

FIG. 2 is a schematic view illustrating when the hybrid power brake control system 100 in FIG. 1 performs braking, and FIG. 3 is a flow chart illustrating a control method of hybrid power brake control system. Referring to FIG. 1, FIG. 2, and FIG. 3 simultaneously, during the moving process of the vehicle, the hybrid power brake control system 100 is usually at the state shown in FIG. 1, the first terminal end 132a of the second connecting rod 132 is located at a third terminal end 131b of the arc-shaped slot 131a.

In step S110, when the first sensor 114 senses that there is an object may cause danger, the first sensor 114 transmits the first sensing result to the judging unit 112. After receiving the first sensing result, the judging unit 112 sends an signal to change the operation of the motor 120 so as to rotate the first connecting rod 131. While the first connecting rod 131 is rotated, the first terminal end 132a, which is engaged into the arc-shaped slot 131a, of the second connecting rod 132 is simultaneously rotated along with the first connecting rod 131 and is moved in the arc-shaped slot 131a from the third terminal end 131b of the arc-shaped slot 131a to be close to a fourth terminal end 131c of the arc-shaped slot 131a. At the same time, the second connecting rod 132 drives the pedal brake 140 to perform breaking function. At this time, the computer 110 controls the breaking behavior.

The breaking behavior of the hybrid power brake control system 100 in the present embodiment may also be controlled by human. To be more specific, when a person/driver controls the vehicle and discover driving obstacles ahead, the driver uses foot to step on the pedal brake 140, the pedal brake 140 drives the second connecting rod 132 to rotate, so the first connecting rod 131 linking with the second connecting rod 132 is rotated. At this time, in step

S120, the second sensor 116 senses the change caused by the pedal brake 140, and the second sensor 116 transmits the second sensing result to the judging unit 112 of the computer 110 to perform breaking function. The change caused by the pedal brake 140, as mentioned above, includes a pressure change of the pedal brake 140, a torque change of the motor 120, and a change in current value of the motor 120.

Especially, the breaking behavior of the hybrid power brake control system 100 in the present embodiment can be controlled by the computer 110 and can also be controlled by human intervention. More specifically, in step S130, when the first sensor 114 transmits the first sensing result to the judging unit 112 in order to drive the motor 120 and the connecting rod set 130 and the pedal brake 140 to perform breaking function, the driver may be aware of an object that causes danger at the same time and reacts to step on the pedal brake 140, so the second sensor 116 senses the change caused by the pedal brake 140, and the judging unit 112 may receive the first sensing result and the second sensing result at the same time or in sequence, and the judging unit 112 cancels the activation of the pedal brake 140 and performs the instruction for breaking. As a result, the breaking function is performed because the driver steps on the pedal brake 140.

In summary, via the hybrid power brake control system and the control method thereof in the disclosure, human can still intervene in the break control system to perform breaking function while the vehicle is under computer control. Therefore, safety of the vehicle that the hybrid power brake control system and the control method thereof are applied to is improved, so as to provide double safety guarantee for driver and passengers.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A hybrid power brake control system, comprising:
a computer;
a motor, electrically connected with the computer;
a connecting rod set, comprising a first connecting rod and a second connecting rod, wherein the first connecting rod is connected with the motor, and a first terminal end of the second connecting rod is connected with the first connecting rod; and
a pedal brake, pivotally connected with a second terminal end of the second connecting rod.

2. The hybrid power brake control system as recited in claim 1, wherein the computer comprises:
a judging unit; and
a first sensor, electrically connected with the judging unit, wherein the first sensor transmits a first sensing result to the judging unit.

3. The hybrid power brake control system as recited in claim 2, wherein the judging unit activates the pedal brake via the first sensing result for braking.

4. The hybrid power brake control system as recited in claim 2, wherein the computer comprises a second sensor, the second sensor senses a change caused by the pedal brake and transmits a second sensing result to the judging unit for braking.

5. The hybrid power brake control system as recited in claim 4, wherein the second sensing result comprises a pressure change of the pedal brake, a torque change of the motor, and a change in current value of the motor.

6. The hybrid power brake control system as recited in claim 1, wherein the first connecting rod has an arc-shaped slot, the first terminal end of the second connecting rod is engaged into the arc-shaped slot, and the first terminal end is movable along the arc-shaped slot.

7. A control method of hybrid power brake control system, comprising:
providing a hybrid power brake control system, wherein the hybrid power brake control system comprises a computer, a motor, a connecting rod set, and a pedal brake, the motor is electrically connected with the computer, and the motor and the pedal brake are connected by the connecting rod set in between; and
when a first sensor of the computer transmits a first sensing result to a judging unit of the computer, activating the pedal brake via the first sensing result for braking by the judging unit.

8. The control method of hybrid power brake control system as recited in claim 7, further comprising when a second sensor of the computer senses a change caused by the pedal brake, a second sensing result is transmitted to the judging unit of the computer.

9. The control method of hybrid power brake control system as recited in claim 8, wherein, when receiving the second sensing result, the judging unit cancels an instruction of activating the pedal brake for braking.

10. The control method of hybrid power brake control system as recited in claim 7, wherein the second sensing result comprises a pressure change of the pedal brake, a torque change of the motor, and a change in current value of the motor.
